(19) United States
(12) Patent Application Publication
(10) Pub. No.: US 2021/0223213 A1
(43) Pub. Date: Jul. 22, 2021

(54) ULTRASONIC DEVICE AND METHOD OF MANUFACTURING ULTRASONIC DEVICE

(71) Applicant: SEIKO EPSON CORPORATION, Tokyo (JP)

(72) Inventor: Hiroshi MATSUDA, Shiojiri-shi (JP)

(21) Appl. No.: 17/248,287

(22) Filed: Jan. 19, 2021

(30) Foreign Application Priority Data
Jan. 21, 2020 (JP) 2020-007647

(51) Int. Cl. G01N 29/24

(52) U.S. Cl. CPC G01N 29/24

(57) ABSTRACT

An ultrasonic device includes: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, and in a plan view of the substrate and the protective substrate in a stacking direction thereof, the opening includes the electrode inside.

The present application is based on, and claims priority from JP Application Serial Number 2020-007647, filed Jan. 21, 2020, the disclosure of which is hereby incorporated by reference herein in its entirety.

### BACKGROUND

### 1. Technical Field

The present disclosure relates to an ultrasonic device and a method of manufacturing an ultrasonic device.

### 2. Related Art

In the related art, an ultrasonic device including a substrate including an element and an electrode of the element is used. For example, FIG. 2A of JP-A-2019-187526 discloses an ultrasonic probe including a substrate including an ultrasonic vibrator and a signal electrode.

However, the ultrasonic probe of FIG. 2A of JP-A-2019-187526 is large in size since a wire bonding and the substrate are arranged in an arrangement direction of the ultrasonic vibrator. Further, as the ultrasonic device in the related art, there is a configuration in which an opening is provided at a position facing the electrode and flexible printed circuits (FPC) or the like are inserted into the opening, but according to such a configuration, the opening needs to be enlarged, and a size of an entire ultrasonic device may also be increased. As described above, it is difficult to reduce the size of the ultrasonic device in the related art including the substrate including the element and the electrode of the element.

### SUMMARY

An object of the present disclosure is to reduce a size of an ultrasonic device.

An ultrasonic device according to an aspect of the present disclosure for solving the above problems includes: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, and in a plan view of the substrate and the protective substrate in a stacking direction thereof, the opening includes the electrode inside.

A method of manufacturing an ultrasonic device according to another aspect of the present disclosure for solving the above problems includes: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, in a plan view of the substrate and the protective substrate in a stacking direction thereof, the opening includes the electrode inside, and the method of manufacturing an ultrasonic device includes: a step of pouring a conductive material in a liquid state into a closed space; and a step of curing the conductive material.

A method of manufacturing an ultrasonic device according to another aspect of the present disclosure for solving the above problems includes: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, and in a plan view of the substrate and the protective substrate in a stacking direction thereof, the opening includes the electrode inside, and the method of manufacturing an ultrasonic device includes: a step of pouring a non-conductive material in a liquid state into a closed space after a wiring is set in a state where one end thereof is coupled to the electrode and the other end thereof protrudes from the closed space; and a step of curing the non-conductive material.

### BRIEF DESCRIPTION OF THE DRAWINGS

FIG. 1 is a schematic diagram showing an ultrasonic sensor according to a first embodiment serving as an example of an ultrasonic device according to the present disclosure.

FIG. 2 is a schematic cross-sectional view of a periphery of a vibrator in a transmission and reception unit of the ultrasonic sensor of FIG. 1.

FIG. 3 is a schematic cross-sectional view showing the periphery of the vibrator in the transmission and reception unit of the ultrasonic sensor of FIG. 1 with a part of components omitted.

FIG. 4 is a schematic plan view showing the periphery of the vibrator in the transmission and reception unit of the ultrasonic sensor of FIG. 1 with the part of the components omitted.

FIG. 5 is a schematic plan view showing a periphery of a vibrator in a transmission and reception unit of an ultrasonic sensor according to a second embodiment with a part of components omitted.

FIG. 6 is a schematic cross-sectional view of a periphery of a vibrator in a transmission and reception unit of an ultrasonic sensor according to a third embodiment.

FIG. 7 is a schematic cross-sectional view showing a periphery of a vibrator in a transmission and reception unit of an ultrasonic sensor of a reference example with a part of components omitted.

FIG. 8 is a schematic plan view showing the periphery of the vibrator in the transmission and reception unit of the ultrasonic sensor of the reference example with the part of the components omitted.

### DESCRIPTION OF EXEMPLARY EMBODIMENTS

First, the present disclosure will be schematically described.

An ultrasonic device according to a first aspect of the present disclosure for solving the above problems includes: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, and in a plan view of the substrate and the protective substrate in a stacking direction thereof, the opening includes the electrode inside.

According to the present aspect, the protective substrate having the opening at a position facing the electrode and the gap material provided between the substrate and the protective substrate are provided, and the opening includes the electrode inside in the plan view. Therefore, for example, by pouring a conductive material into a closed space, or by pouring a non-conductive material after a wiring is set in a state where one end thereof is coupled to the electrode and the other end thereof protrudes from the closed space, the closed space can be made into a compact electrode terminal. Therefore, the ultrasonic device can be reduced in size.

The ultrasonic device according to a second aspect of the present disclosure is directed to the first aspect, in which a wiring electrically coupled to the electrode is surrounded by the substrate, the electrode, the gap material, and the protective substrate, and the wiring is made of a conductive resin.

According to the present aspect, since the wiring is made of a conductive resin, the closed space can be easily made into a compact electrode terminal.

The ultrasonic device according to a third aspect of the present disclosure is directed to the first aspect, in which a wiring electrically coupled to the electrode is surrounded by the substrate, the electrode, the gap material, and the protective substrate, one end of the wiring is electrically coupled to the electrode, and a non-conductive resin is provided between the wiring and the substrate, the gap material, and the protective substrate.

According to the present aspect, the non-conductive resin and the wiring whose one end is coupled to the electrode are provided. Therefore, the wiring can be made into a compact electrode terminal.

The ultrasonic device according to a fourth aspect of the present disclosure is directed to the second or third aspect, in which the wiring projects from an opposite side of the protective substrate from a substrate side of the protective substrate in a direction in which the substrate and the protective substrate overlap.

According to the present aspect, the wiring projects from the opposite side of the protective substrate from the substrate side of the protective substrate in the direction in which the substrate and the protective substrate overlap. Therefore, for example, the wiring can be prevented from being an obstacle in a configuration in which the ultrasonic waves are transmitted to and received from the substrate side.

The ultrasonic device according to a fifth aspect of the present disclosure is directed to any one of the first to fourth aspects, in which the gap material overlaps the electrode in the direction in which the substrate and the protective substrate overlap.

According to the present aspect, the gap material is provided so as to overlap the electrode. Therefore, as compared to a configuration in which the gap material is provided so as not to overlap the electrode, the ultrasonic device can be configured compactly in a direction intersecting the direction in which the substrate and the protective substrate overlap.

The ultrasonic device according to a sixth aspect of the present disclosure is directed to any one of the first to fifth aspects, in which the gap material is made of a photosensitive resin.

According to the present aspect, the gap material can be easily and highly accurately configured by using the photosensitive resin.

A method of manufacturing an ultrasonic device according to a seventh aspect of the present disclosure is a method of manufacturing an ultrasonic device including: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, in a plan view of the substrate and the protective substrate in a stacking direction thereof, the opening includes the electrode inside, and the method of manufacturing an ultrasonic device includes: a step of pouring a conductive material in a liquid state into a closed space; and a step of curing the conductive material.

According to the present aspect, the closed space can be made into a compact electrode terminal by pouring the conductive material into the closed space. Therefore, the ultrasonic device can be reduced in size.

A method of manufacturing an ultrasonic device according to an eighth aspect of the present disclosure is a method of manufacturing an ultrasonic device including: a substrate that includes, at a first surface thereof, one or more vibrators that generate ultrasonic waves by vibrating and a plurality of electrodes coupled to the vibrators; a protective substrate that protects the vibrators and is provided with an opening facing the electrode on a first surface side of the substrate; and a gap material that provides a gap between the substrate and the protective substrate, in a plan view of the substrate and the protective substrate in a stacking direction thereof, the opening includes the electrode inside, and the method of manufacturing an ultrasonic device includes: a step of pouring a non-conductive material in a liquid state into a closed space after a wiring is set in a state where one end thereof is coupled to the electrode and the other end thereof protrudes from the closed space; and a step of curing the non-conductive material.

According to the present aspect, by pouring the non-conductive material after the wiring is set in the state where one end thereof is coupled to the electrode and the other end thereof protrudes from the closed space, the closed space can be made into a compact electrode terminal. Therefore, the ultrasonic device can be reduced in size.

Hereinafter, embodiments of the present disclosure will be described with reference to accompanying drawings.

### First Embodiment

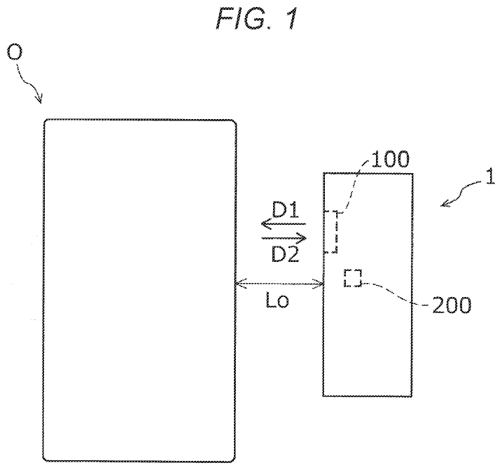

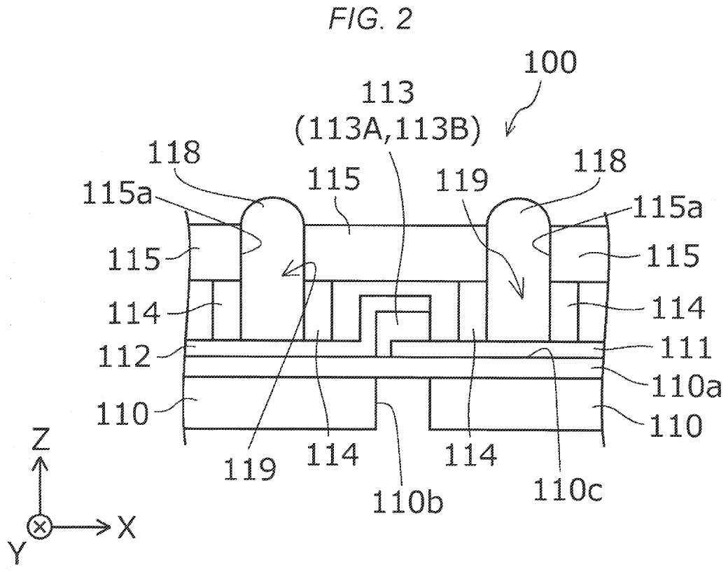

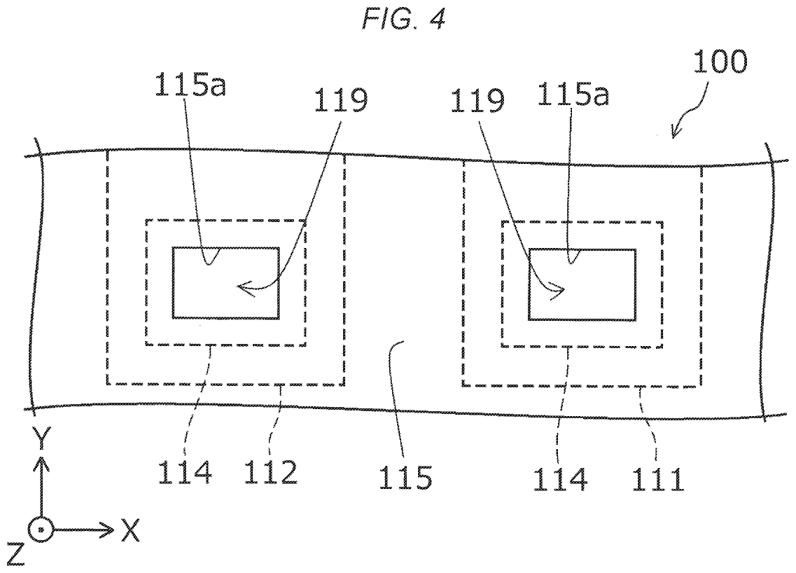

First, an ultrasonic sensor 1 according to a first embodiment serving as an example of the ultrasonic device according to the present disclosure will be described with reference to FIGS. 1 to 4. The ultrasonic device of the present embodiment is the ultrasonic sensor, but the present disclosure is not limited to the ultrasonic sensor. Here, in FIGS. 2 to 4, when a substantially flat plate-shaped transmission and reception unit 100 is placed on a horizontal plane, a state represented by FIG. 4 is a plan view. In FIGS. 2 to 4, an X axis direction is a horizontal direction, a Y axis direction is a horizontal direction orthogonal to the X axis direction, and a Z axis direction is a vertical direction.

As shown in FIG. 1, the ultrasonic sensor 1 includes the transmission and reception unit 100 that transmits ultrasonic waves in a transmission direction D1 and receives ultrasonic waves that move in a reception direction D2 due to reflection by an object O. The transmission and reception unit 100 includes, as vibrators 113, a transmission element 113A that generates ultrasonic waves by vibrating, and a reception element 113B that has a configuration similar to that of the transmission element 113A and receives the ultrasonic waves transmitted from the transmission element 113A. The transmission element 113A and the reception element 113B as the vibrators 113 both have the same shape, and specifically, each include a configuration as shown in FIG. 2.

Further, as shown in FIG. 1, the ultrasonic sensor 1 includes a timer 200 that measures time until the ultrasonic waves transmitted from the transmission and reception unit 100 are received. The ultrasonic sensor 1 can measure a distance Lo from the ultrasonic sensor 1 to the object O based on the time measured by the timer 200.

Next, a specific configuration of a peripheral portion of the vibrators 113 in the transmission and reception unit 100 will be described. As shown in FIG. 2, the transmission and reception unit 100 includes a substrate 110 including, on a first surface 110c of a diaphragm 110a, the vibrators 113 and a first electrode 111 and a second electrode 112 as a plurality of electrodes coupled to the vibrators 113. Further, the transmission and reception unit 100 includes a protective substrate 115, and the protective substrate 115 protects the vibrators 113 and is provided with openings 115a provided on a first surface 110c side with respect to the substrate 110 at positions facing the first electrode 111 and the second electrode 112. Further, a gap material 114 that provides a gap between the substrate 110 and the protective substrate 115 is provided.

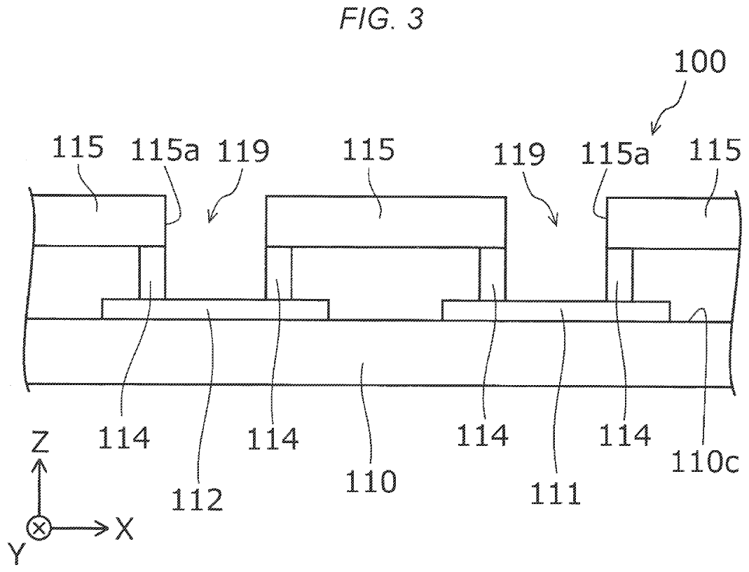

Here, in FIG. 3, in order to make it easier to understand the configuration of the peripheral portion of the vibrators 113 in the transmission and reception unit 100, the vibrators 113, the diaphragm 110a, a conductive resin 118 to be described later, or the like are omitted and the whole configuration is simplified. FIG. 4 is a plan view of FIG. 3. As shown in FIG. 4, in the plan view of the substrate 110 and the protective substrate 115 in a stacking direction thereof, the openings 115a respectively include the first electrode 111 and the second electrode 112 inside. Although two openings 115a are shown in FIGS. 3 and 4, the opening 115a on a right side of FIGS. 3 and 4 is an opening 119 in a state of including only the first electrode 111. Further, the opening 115a on a left side of FIGS. 3 and 4 is an opening 119 in a state of including only the second electrode 112. That is, the opening 115a is the opening 119 in a state of including only one electrode among the plurality of electrodes.

Then, as shown in FIG. 2, the conductive resin 118 is provided in the opening 119. In other words, a wiring in the ultrasonic sensor 1 of the present embodiment is the conductive resin 118. Specifically, by executing a step of pouring the conductive resin 118, which is a conductive material in a liquid state, into the opening 119, and a step of curing the conductive resin 118, the conductive material electrically coupled to the electrode projects from the opening 115a.

Therefore, in the ultrasonic sensor 1 of the present embodiment, the openings 119 are set as compact electrode terminals. Therefore, the ultrasonic sensor 1 of the present embodiment is an ultrasonic device reduced in size by including the transmission and reception unit 100 having such a configuration.

In particular, in the ultrasonic sensor 1 of the present embodiment, as shown in FIG. 2, since the conductive resin 118 is raised from the opening 115a, the conductive resin 118 raised from the opening 115a is used as a convenient and compact electrode terminal.

Further, as shown in FIGS. 2 and 3, in the ultrasonic sensor 1 of the present embodiment, the gap material 114 is provided so as to be placed on the first electrode 111 or the second electrode 112. That is, the gap material 114 overlaps the electrode in a direction in which the substrate 110 and the protective substrate 115 overlap. Therefore, as compared with a configuration in which the gap material 114 is provided so as not to overlap the electrode, the ultrasonic sensor 1 of the present embodiment is an ultrasonic device reduced in size in a direction intersecting the Z axis direction which is the direction in which the substrate 110 and the protective substrate 115 overlap.

The gap material 114 of the present embodiment is made of a photosensitive resin, and the gap material 114 is easily and highly accurately configured by using the photosensitive resin. However, a constituent material of the gap material 114 is not particularly limited.

As shown in FIG. 4, the opening 115a of the present embodiment has a rectangular shape in the plan view. However, the opening 115a is not limited to such a configuration. For example, the opening 115a may have a circular or elliptical shape in the plan view. When the opening 115a has a circular or elliptical shape in the plan view, the gap material 114 can also have a circular or elliptical ring shape in the plan view.

In the ultrasonic sensor 1 of the present embodiment, as shown in FIGS. 2 to 4, a position of the opening 115a and a position of an end portion of the gap material 114 are aligned in the plan view. However, the present disclosure is not limited to such a configuration. For example, the position of the opening 115a may be inward than the position of the end portion of the gap material 114 in the plan view.

In the ultrasonic sensor 1 of the present embodiment, the substrate 110 and the gap material 114, and the protective substrate 115 and the gap material 114 are directly coupled. However, the present disclosure is not limited to such a configuration. For example, the substrate 110 and the gap material 114, and the protective substrate 115 and the gap material 114 may be indirectly coupled via an adhesive or the like.

Further, as shown in FIG. 2, since the ultrasonic device of the present embodiment is the ultrasonic sensor 1, the substrate 110 is provided with an ultrasonic inlet and outlet 110b. However, depending on the ultrasonic device to which the present disclosure is applied, a configuration that does not include such an inlet and outlet 110b may be used.

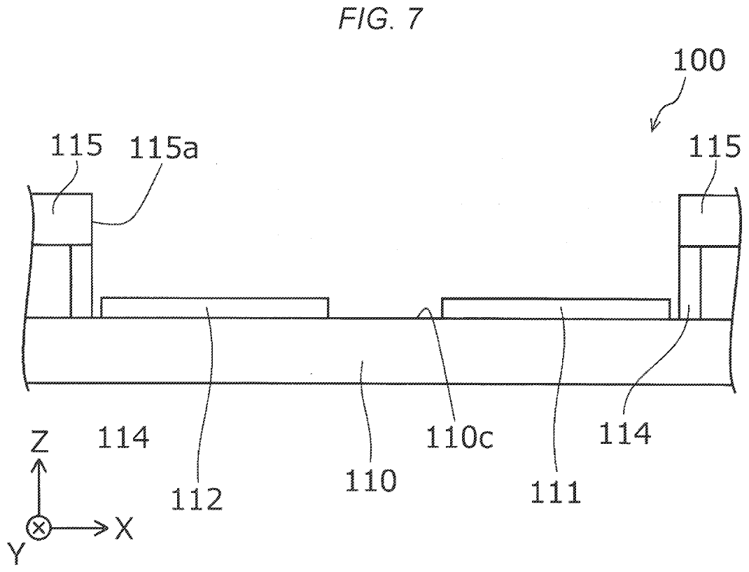

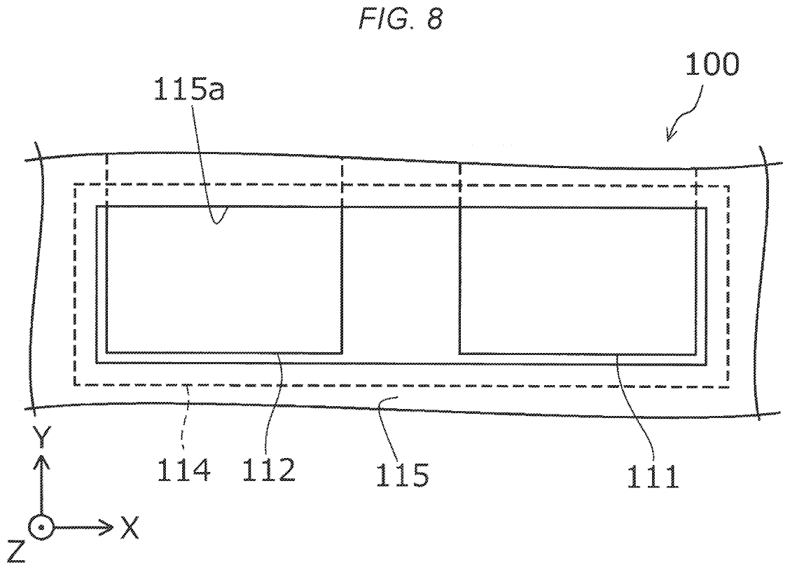

Here, an example of an electrode terminal in an ultrasonic sensor of a reference example as a general ultrasonic device in the related art will be described with reference to FIGS. 7 and 8. As shown in FIGS. 7 and 8, in the ultrasonic sensor of the reference example, the opening 115a is provided so as to include a plurality of electrodes in a plan view. In such a configuration, for example, in order to form an electrode terminal that is securely coupled to the first electrode 111 and the second electrode 112 without short-circuiting the first electrode 111 and the second electrode 112, a portion forming the electrode terminal tends to be large. Specifically, for example, an insertion mechanism for inserting flexible printed circuits (FPCs), a fixing mechanism for fixing the FPCs, or the like need to be provided, and the portion forming the electrode terminal may be large.

The material of the first electrode 111 or the second electrode 112 is not limited as long as the first electrode 111 or the second electrode 112 is conductive. Examples of the material of the first electrode 111 or the second electrode 112 include a metal material such as platinum (Pt), iridium (Ir), gold (Au), aluminum (Al), copper (Cu), titanium (Ti), and stainless steel, a Tin oxide-based conductive material such as an indium tin oxide (ITO) and a fluorine-doped tin oxide (FTC)), a zinc oxide-based conductive material, an oxide conductive material such as strontium ruthenate (SrRuO₃), lanthanum nickel oxide (LaNiO₃), and element-doped strontium titanate, or a conductive polymer.

The vibrators 113 can be formed by a piezoelectric layer or the like, and as the piezoelectric layer, a composite oxide having a lead zirconate titanate (PZT)-based perovskite structure (ABO₃ type structure) can be typically used. Accordingly, a displacement amount of the vibrators 113 can be easily secured.

Further, as the piezoelectric layer, a composite oxide including a perovskite structure (ABO₃ type structure) containing no lead can also be used. Accordingly, the ultrasonic sensor 1 can be implemented by using a lead-free material having a small load on an environment.

An example of such a lead-free piezoelectric material includes a BFO-based material containing bismuth ferrite (BFO and BiFeO₃). In the BFO, Bi is positioned at an A site, and iron (Fe) is positioned at a B site. Other elements may be added to the BFO. For example, at least one element selected from manganese (Mn), aluminum (Al), lanthanum (La), barium (Ba), titanium (Ti), cobalt (Co), cerium (Ce), samarium (Sm), chromium (Cr), potassium (K), lithium (Li), calcium (Ca), strontium (Sr), vanadium (V), niobium (Nb), tantalum (Ta), molybdenum (Mo), tungsten (W), nickel (Ni), zinc (Zn), praseodymium (Pr), neodymium (Nd), and europium (Eu) may be added to the BFO.

Another example of the lead-free piezoelectric material includes a KNN-based material containing potassium sodium niobate (KNN and KNaNbO₃). Other elements may be added to the KNN. For example, at least one element selected from manganese (Mn), lithium (Li), barium (Ba), calcium (Ca), strontium (Sr), zirconium (Zr), titanium (Ti), bismuth (Bi), tantalum (Ta), antimony (Sb), iron (Fe), cobalt (Co), silver (Ag), magnesium (Mg), zinc (Zn), copper (Cu), vanadium (V), chromium (Cr), molybdenum (Mo), tungsten (W), nickel (Ni), Aluminum (Al), silicon (Si), lanthanum (La), cerium (Ce), praseodymium (Pr), neodymium (Nd), promethium (Pm), samarium (Sm), and europium (Eu) may be added to the KNN.

The composite oxide of the perovskite structure includes a composite oxide deviated from a stoichiometric composition due to deficiency and excess or a composite oxide in which a part of elements is replaced with other elements. That is, as long as the perovskite structure is obtained, not only unavoidable compositional deviations due to lattice mismatch, oxygen deficiency, or the like, but also partial substitution of elements are allowed.

### Second Embodiment

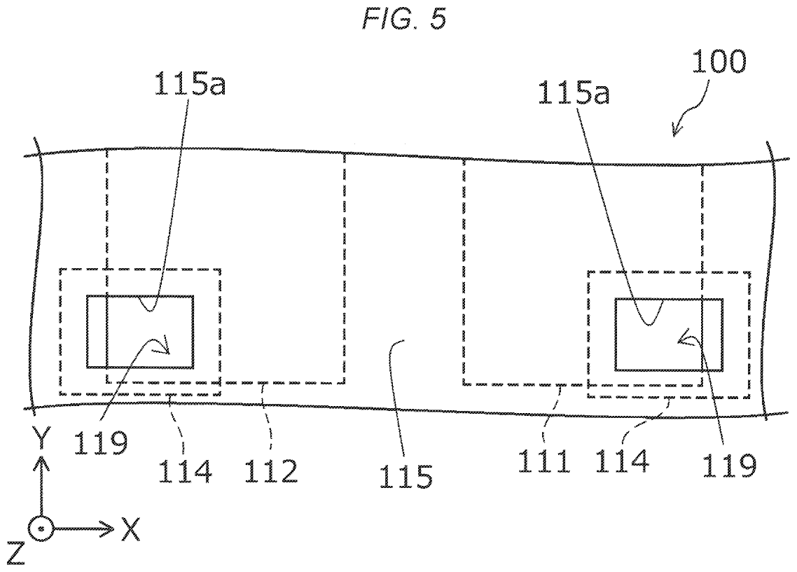

Next, an ultrasonic sensor according to a second embodiment will be described with reference to FIG. 5. FIG. 5 corresponds to FIG. 4 showing the ultrasonic sensor 1 according to the first embodiment, and in FIG. 5, components common to those in the first embodiment will be denoted by the same reference numerals and detailed description thereof will be omitted. The ultrasonic sensor according to the present embodiment has characteristics similar to those of the ultrasonic sensor 1 according to the first embodiment described above, and has the same configuration as the ultrasonic sensor 1 according to the first embodiment except the following points. Specifically, the ultrasonic sensor has the same configuration as the ultrasonic sensor 1 according to the first embodiment except the configuration of the transmission and reception unit 100.

As shown in FIG. 4, the transmission and reception unit 100 in the ultrasonic sensor 1 of the first embodiment is provided such that the gap material 114 completely rests on the first electrode 111 or the second electrode 112 in the plan view. Accordingly, the opening 115a and the opening 119 are also completely disposed on the first electrode 111 or the second electrode 112 in the plan view.

On the other hand, as shown in FIG. 5, the transmission and reception unit 100 in the ultrasonic sensor of the present embodiment is provided such that only a part of the gap material 114 rests on the first electrode 111 or the second electrode 112 in the plan view. Accordingly, only a part of the opening 115a and the opening 119 is disposed on the first electrode 111 or the second electrode 112 in the plan view. A configuration in which the opening 115a and the opening 119 are completely disposed on the first electrode 111 or the second electrode 112 in the plan view is more effective in preventing a contact defect. However, the configuration in which only a part of the opening 115a and the opening 119 is disposed on the first electrode 111 or the second electrode 112 in the plan view may make the first electrode 111 or the second electrode 112 more compact. In such a case, the ultrasonic sensor may be further reduced in size as compared with the ultrasonic sensor 1 of the first embodiment.

### Third Embodiment

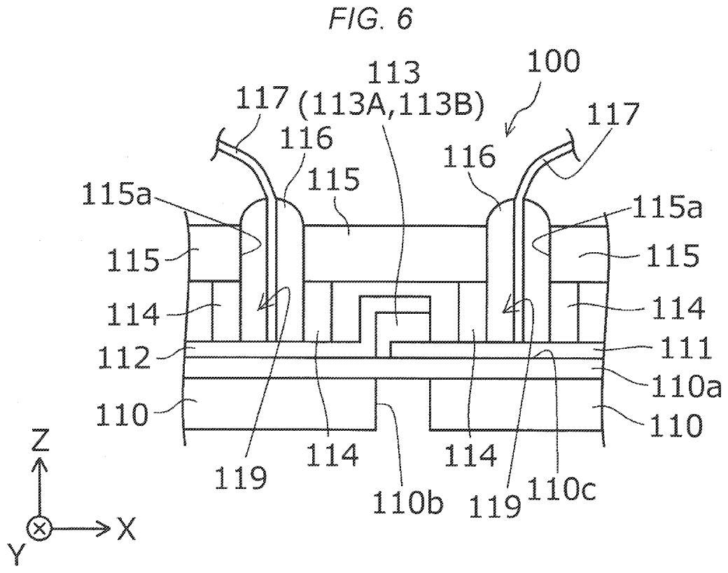

Next, an ultrasonic sensor according to a third embodiment will be described with reference to FIG. 6. FIG. 6 corresponds to FIG. 2 showing the ultrasonic sensor 1 according to the first embodiment, and in FIG. 6, components common to those in the first and second embodiments will be denoted by the same reference numerals and detailed description thereof will be omitted. The ultrasonic sensor according to the present embodiment has characteristics similar to those of the ultrasonic sensor 1 according to the above first and second embodiments, and has the same configuration as the ultrasonic sensor 1 according to the first and second embodiments except the following points. Specifically, the ultrasonic sensor has the same configuration as the ultrasonic sensor 1 according to the first and second embodiments except the configuration of the transmission and reception unit 100.

As shown in FIG. 6, the ultrasonic sensor of the present embodiment includes, in the openings 119, non-conductive resin 116 and wirings 117, one end of the wiring 117 is coupled to the first electrode 111 or the second electrode 112 and the other end of the wiring 117 protrudes from the opening 119. In other words, the wiring 117 electrically coupled to the electrode is surrounded by the substrate 110, the electrode, the gap material 114, and the protective substrate 115, one end of the wiring 117 is electrically coupled to the electrode, and the non-conductive resin 116 is provided between the wiring 117 and the substrate 110, the gap material 114, and the protective substrate 115. Specifically, after the wiring 117 is set in the opening 119 in a state where one end thereof is coupled to the first electrode 111 or the second electrode 112 and the other end protrudes from the opening 119, by executing a step of pouring the non-conductive resin 116, which is a non-conductive material in a liquid state, into the opening 119, and a step of curing the non-conductive resin 116, the wiring 117 also serves as an electrode terminal. The ultrasonic sensor of the present embodiment includes such a configuration, and therefore the wiring 117 is a compact electrode terminal.

When the ultrasonic sensor of the present embodiment is described from another point of view, as shown in FIG. 6, in the ultrasonic sensor of the present embodiment, the wiring 117 is surrounded by the gap material 114 and the protective substrate 115 in a direction intersecting the Z axis direction. Therefore, it is difficult for the wiring 117 to come off from the substrate 110.

Further, as shown in FIG. 6, in the ultrasonic sensor of the present embodiment, the wiring 117 protrudes from an opposite side of the protective substrate 115 from the substrate 110 side in the Z axis direction. According to such a configuration, the wiring 117 can be prevented from being an obstacle in a configuration in which the inlet and outlet 110b is provided on the substrate 110 side and the ultrasonic waves are transmitted to and received from the substrate 110 side.

The present disclosure is not limited to the embodiments described above, and can be implemented in various configurations without departing from the scope of the disclosure. In order to solve some or all of problems described above, or to achieve some or all of effects described above, technical characteristics in the embodiments corresponding to technical characteristics in aspects described in the summary can be replaced or combined as appropriate. If the technical characteristics are not described as essential in the present description, the technical characteristics can be deleted as appropriate.

What is claimed is:

1. An ultrasonic device, comprising:
a substrate that includes, at a first surface thereof, one or more vibrators that generate ultrasonic waves by vibrating and a plurality of electrodes coupled to the vibrators;
a protective substrate that is arranged to face the first surface and is provided with an opening at a position facing the electrode; and
a gap material that provides a gap between the substrate and the protective substrate, wherein
in a plan view of the substrate and the protective substrate in a stacking direction thereof, the opening includes the electrode inside.

2. The ultrasonic device according to claim 1, wherein
a wiring electrically coupled to the electrode is surrounded by the substrate, the electrode, the gap material, and the protective substrate,
one end of the wiring is electrically coupled to the electrode, and
a non-conductive resin is provided between the wiring and the substrate, the gap material, and the protective substrate.

3. The ultrasonic device according to claim 2, wherein
the wiring is made of a conductive resin.

4. The ultrasonic device according to claim 2, wherein
the wiring projects from an opposite-side surface of the protective substrate from a surface of the protective substrate facing the substrate in a direction in which the substrate and the protective substrate overlap.

5. The ultrasonic device according to claim 1, wherein
the gap material overlaps the electrode in a direction in which the substrate and the protective substrate overlap.

6. The ultrasonic device according to claim 1, wherein
the gap material is made of a photosensitive resin.

7. A method of manufacturing an ultrasonic device,
the ultrasonic device including:
a substrate that includes, at a first surface thereof, one or more vibrators that generate ultrasonic waves by vibrating and a plurality of electrodes coupled to the vibrators;
a protective substrate that is arranged to face the first surface and is provided with an opening at a position facing the electrode; and
a gap material that provides a gap between the substrate and the protective substrate, and
in a plan view of the substrate and the protective substrate in a stacking direction thereof, the opening including the electrode inside,
the method of manufacturing an ultrasonic device comprising:
a step of pouring a conductive material in a liquid state into a closed space; and
a step of curing the conductive material.

8. A method of manufacturing an ultrasonic device,
the ultrasonic device including:
a substrate that includes, at a first surface thereof, one or more vibrators that generate ultrasonic waves by vibrating and a plurality of electrodes coupled to the vibrators;
a protective substrate that is arranged to face the first surface and is provided with an opening at a position facing the electrode; and
a gap material that provides a gap between the substrate and the protective substrate, and
in a plan view of the substrate and the protective substrate in a stacking direction thereof, the opening including the electrode inside,
the method of manufacturing an ultrasonic device comprising:
a step of pouring a non-conductive material in a liquid state into a closed space after a wiring is set in a state where one end thereof is coupled to the electrode and the other end thereof protrudes from the closed space; and
a step of curing the non-conductive material.
